(19) United States
(12) Patent Application Publication
(10) Pub. No.: US 2025/0135341 A1
(43) Pub. Date: May 1, 2025

(54) INTERACTION METHOD AND APPARATUS BASED ON VIRTUAL OBJECTS, ELECTRONIC DEVICE, AND STORAGE MEDIUM

(71) Applicant: Tencent Technology (Shenzhen) Company Limited, Shenzhen (CN)

(72) Inventors: Linying XIE, Shenzhen (CN); Jiaqi Pan, Shenzhen (CN); Yue Bai, Shenzhen (CN); Kaiqin Xu, Shenzhen (CN); Ying Deng, Shenzhen (CN); Weixiang Yu, Shenzhen (CN); Wenyi Li, Shenzhen (CN); Yinglei Wang, Shenzhen (CN); Yun Yang, Shenzhen (CN); Zefeng Yang, Shenzhen (CN)

(21) Appl. No.: 19/009,303

(22) Filed: Jan. 3, 2025

Related U.S. Application Data
(63) Continuation of application No. PCT/CN2023/130194, filed on Nov. 7, 2023.

(30) Foreign Application Priority Data
Jan. 16, 2023 (CN) 202310092019.2

(51) Int. Cl. A63F 13/533; A63F 13/42; A63F 13/56; A63F 13/577; A63F 13/795; G06F 3/04815; G06F 3/0482; G06F 3/04886

(52) U.S. Cl. CPC A63F 13/533; A63F 13/42; A63F 13/577; A63F 13/795; G06F 3/04815; G06F 3/0482; G06F 3/04886; A63F 13/56

(57) ABSTRACT

A method for performing interactions between virtual objects in a virtual environment is performed by an electronic device. The method includes: displaying an interaction interface, the interface including one or more selectable interactions; in response to a trigger operation for any interaction, displaying an action marker of the interaction associated with a first virtual object; and when at least one second virtual object appears within an interaction range of the first virtual object and carries the action marker of the interaction, playing a marker fusion special effect based on a plurality of action markers within the interaction range, the marker fusion special effect providing an interaction special effect when the plurality of action markers converge within the interaction range. By using the above method, the interaction modes based on interactions are enriched.

### CROSS-REFERENCE TO RELATED APPLICATIONS

This application is a continuation application of PCT Patent Application No. PCT/CN2023/130194, entitled “INTERACTION METHOD AND APPARATUS BASED ON VIRTUAL OBJECTS, ELECTRONIC DEVICE, AND STORAGE MEDIUM” filed on Nov. 7, 2023, which claims priority to Chinese Patent Application No. 202310092019.2, entitled “INTERACTION METHOD AND APPARATUS BASED ON VIRTUAL OBJECTS, ELECTRONIC DEVICE, AND STORAGE MEDIUM” filed on Jan. 16, 2023, both of which are incorporated herein by reference in their entirety.

### FIELD OF THE TECHNOLOGY

This application relates to the technical field of computers, and in particular, to an interaction method and apparatus based on virtual objects, an electronic device, and a storage medium.

### BACKGROUND OF THE DISCLOSURE

With the development of computer technology and the diversification of terminal functions, users can play games anytime and anywhere using terminals. Massive multiplayer online games (MMOGs), shooter games, survival games, and other games usually have strong social attributes. Therefore, social systems are important systems in game service logic, which can promote players to establish connections and communicate with each other.

In the social systems of current mainstream games, interaction methods based on virtual objects are usually as follows: a player opens an emoji wheel through an emoji entry and taps an emoji the player intends to send in the emoji wheel, so that the emoji is displayed around a virtual object controlled by the player in a form of texture projection.

### SUMMARY

Embodiments of this application provide an interaction method and apparatus based on virtual objects, an electronic device, and a storage medium, which can increase a degree of integration between an interaction and a virtual scenario, improve a real-time interaction feeling and immersive feeling, and improve the human-computer interaction efficiency. The technical solutions are as follows:

In an aspect, a method for performing interactions between virtual objects in a virtual environment is performed by an electronic device, the method comprising:
displaying an interaction interface, the interface including one or more selectable interactions;
in response to a trigger operation for any interaction, displaying an action marker of the interaction associated with a first virtual object; and
when at least one second virtual object appears within an interaction range of the first virtual object and carries the action marker of the interaction, playing a marker fusion special effect based on a plurality of action markers within the interaction range, the marker fusion special effect providing an interaction special effect when the plurality of action markers converge within the interaction range.

In an aspect, an electronic device is provided, including one or more processors and one or more memories, the one or more memories having at least one computer program stored therein, and the at least one computer program being loaded and run by the one or more processors to cause the electronic device to implement the above interaction method based on virtual objects.

In an aspect, a non-transitory computer-readable storage medium is provided, having at least one computer program stored therein, and the at least one computer program being loaded and run by a processor, to cause a computer to implement the above interaction method based on virtual objects.

By providing a quick interaction mode based on interactions, a user can control a first virtual object to initiate any interaction after opening an interaction interface through an interaction control, and combine and play a marker fusion special effect according to second virtual objects that initiate the same interaction within an interaction range of the first virtual object, to indicate that an action marker of the first virtual object and action markers of the second virtual objects converge through multiplayer interaction, thus displaying and providing a multiplayer social interaction form between two or more virtual objects, enriching the interaction modes based on the interactions, increasing a degree of integration with a virtual scenario, improving a real-time interaction feeling and immersive feeling, and improving the human-computer interaction efficiency.

### BRIEF DESCRIPTION OF THE DRAWINGS

FIG. 1 is a schematic diagram of an implementation environment of an interaction method based on virtual objects according to an embodiment of this application.

FIG. 2 is a flowchart of an interaction method based on virtual objects according to an embodiment of this application.

FIG. 3 is a schematic diagram of an interaction control according to an embodiment of this application.

FIG. 4 is a schematic diagram of an interaction interface according to an embodiment of this application.

FIG. 5 is a schematic diagram of an action marker of an interaction according to an embodiment of this application.

FIG. 6 is a schematic diagram of a marker fusion special effect according to an embodiment of this application.

FIG. 7 is a flowchart of an interaction method based on virtual objects according to an embodiment of this application.

FIG. 8 is a schematic diagram of detection of a tap gesture according to an embodiment of this application.

FIG. 9 is a schematic diagram of detection of a slide gesture according to an embodiment of this application.

FIG. 10 is a schematic diagram of mode I for participating in multiplayer interaction according to an embodiment of this application.

FIG. 11 is a schematic diagram of mode II for participating in multiplayer interaction according to an embodiment of this application.

FIG. 12 is a schematic diagram of another marker fusion special effect according to an embodiment of this application.

FIG. 13 is a schematic flowchart of an interaction method based on virtual objects according to an embodiment of this application.

FIG. 14 is a schematic structural diagram of an interaction apparatus based on virtual objects according to an embodiment of this application.

FIG. 15 is a schematic structural diagram of an electronic device according to an embodiment of this application.

### DESCRIPTION OF EMBODIMENTS

To make the objectives, technical solutions, and advantages of this application clearer, the following further describes implementations of this application in detail with reference to the accompanying drawings.

The terms “first”, “second”, and the like used in this application are used for distinguishing identical or similar items that have essentially the same effects and functions. There is no logical or temporal dependency relationship between “first”, “second”, and “nth”, and there is no limitation on quantities and execution orders.

In this application, the term “at least one” means one or more, and “a plurality” means two or more. For example, a plurality of action markers means two or more action markers.

In this application, the term “including at least one of A or B” involves the following several cases: including only A, including only B, and including both A and B.

User-related information (including but not limited to device information, personal information, behavior information, and the like of a user), data (including but not limited to data used for analysis, stored data, displayed data, and the like), and a signal in this application are all licensed, approved, authorized by the user, or fully authorized by all parties when the method in the embodiments of this application is applied to a specific product or technology, and collection, use, and processing of the related information, the data, and the signal need to comply with related laws, regulations, and standards of a related country or region. For example, a trigger operation for an interaction control, a trigger operation for an interaction, and the like involved in this application are obtained under full authorization.

Terms in this application are explained below.

Massive Multiplayer Online Game (MMOG): any game where a large number of players can be online simultaneously through an online game server can be referred to as an MMOG.

Shooter Game (STG): it means a game in which a virtual object uses a shooting virtual prop for remote attacks. The shooter game is a kind of action game with significant characteristics of action games. In some embodiments, the shooter game includes but is not limited to a first-personal shooting (FPS) game, a third-personal shooting (TPS) game, a top-down shooting game, a head-up shooting game, a platform shooting game, a scrolling shooting game, a keyboard and mouse shooting game, a shooting range game, and the like. The embodiments of this application do not specifically limit the type of the shooter game.

The FPS game is played from a subjective field of view of a main control virtual object (i.e. a game character) of a user. Unlike other types of games in which the entire main control virtual object can be seen, in the FPS game, except for a virtual scenario and an enemy virtual object, the user can usually only see hands of the main control virtual object and a virtual prop held in the hands, or the user cannot see the main control virtual object. Compared with a field of view of the FPS game, a field of view of the TPS game moves beyond the main control virtual object, usually in a back or back shoulder region of the main control virtual object. In the TPS game, the user can see a full body model or a half body model of the main control virtual object. When shooting, the user can usually switch between hip fire (shooting without opening a sight) and aiming down sight (ADS, also referred to as aimed shooting, namely, shooting after opening a sight, adjusting a collimator, and then firing). The FPS game and the TPS game are two main forms of current shooter games, both of which have a core experience of searching and shooting targets.

Survival game: it is a type of multiplayer online competitive game in which a set number of virtual objects controlled by players are put into the same virtual scenario, and ultimate survival in the virtual scenario is taken as a victory condition. In the survival game, the players can choose to form a single-player team or form a team for cooperation, which means that the team at least contains a virtual object controlled by one player, and virtual objects belonging to different teams form an adversarial relationship. If there is at least one virtual object that has not been eliminated in a team, it is considered that the entire team has not been eliminated. If all virtual objects in the team have been eliminated, it is considered that the entire team has been eliminated. When in a game, new environmental elements usually spawn in the virtual scenario or original environmental elements may be changed, so that the game is full of variations. Different teams can use the environmental elements for ambushing and fighting until there is only one team in the virtual scenario that has not been eliminated, namely, all the virtual objects currently surviving in the virtual scenario belong to the same team. When the game ends, the team that has not been eliminated wins.

Virtual scenario: it is a virtual environment that an application program displays (or provides) when running on a terminal. The virtual scenario may be a simulated environment of a real world, or may be a semi-simulated semi-fictional virtual environment, or may be an entirely fictional virtual environment. The virtual scenario may be any one of a two-dimensional virtual scenario, a 2.5-dimensional virtual scenario, or a three-dimensional virtual scenario, and the dimension of the virtual scenario is not limited in the embodiments of this application. For example, the virtual scenario may include a sky, a land, an ocean, and the like. The land includes environmental elements such as a desert and a city. A user can control a virtual object to move in the virtual scenario. In some embodiments, the virtual scenario may be further configured for a virtual scenario confrontation between at least two virtual objects, and there are virtual resources available to the at least two virtual objects in the virtual scenario.

Virtual object: it is a movable object in a virtual scenario. The movable object may be a virtual person, a virtual animal, a cartoon person, or the like, for example, a person, an animal, a plant, an oil drum, a wall, or a stone displayed in a virtual scenario. The virtual object may be a virtual image configured for representing a user in the virtual scenario. The virtual scenario may include a plurality of virtual objects, and each virtual object has a shape and a volume in the virtual scenario, and occupies a partial space in the virtual scenario. In some embodiments, when a virtual scenario is a three-dimensional virtual scenario, a virtual object may be a three-dimensional model, and the three-dimensional model may be a three-dimensional character built based on a three-dimensional human skeleton technology. One virtual object may show different external appearances by wearing different skins. In some embodiments, the virtual object may also be implemented by using a 2.5-dimensional model or a two-dimensional model. This is not limited in the embodiments of this application.

In some embodiments, the virtual object may be a player character controlled through an operation on a client, or may be a non-player character (NPC) that can achieve interaction in a virtual scenario or a neutral virtual object (e.g. a monster that provides a gain BUFF, an empirical value, or other resources), or may be a game robot set in a virtual scenario (e.g. an accompanying robot). Schematically, the virtual object is a virtual person for competition in a virtual scenario. In some embodiments, a number of virtual objects participating in the interaction in the virtual scenario may be preset, or may be dynamically determined according to a number of clients participating in the interaction.

A social system is an important system in MMOG games such as the FPS game and a multiplayer online battle arena (MOBA) game, which can promote players to establish connections, communication with each other, cultivate tacit understanding, and enhance user stickiness of a game. In the social system, players can complete social interactions by talking, chatting, and sending emojis, but the real-time interaction feeling and immersive feeling in a game are poor, making it difficult to provide the players with a surprising experience.

Taking emoji socialization as an example, players can select emojis (such as emojis) through emoji wheel and display them in a texture projection around virtual objects controlled by the player. However, on the one hand, due to simple texture projection of an emoji have a relatively low degree of integration with a virtual scenario, real-time interaction feeling and immersive feeling are low and human-computer interaction efficiency is low. On the other hand, other players are unable to provide direct feedback or make a direct response to the emoji, making it difficult to engage in targeted interaction. This results in a weak sense of connection among players and wastes potential social opportunities.

In view of this, an embodiment of this application provides an interaction method based on virtual objects, in which players can make a quick response based on natural actions of the virtual objects, and multiple players are supported to participate in social interactions, thus simulating friendly interactions in a real world. For example, the virtual objects controlled by the players can interact with each other when they approach, such as displaying action markers of interactions such as high five, hugging, and shaking hands. In a virtual scenario allowing free movement, after a player initiates an interaction on a virtual object, an action marker of the interaction will be displayed around the virtual object. For example, if the interaction is high five, the action marker will be a palm. Then, one or more players within an interaction range of the virtual object can perform a trigger operation on the action marker within limited time to respond to the interaction initiated by the player, so that a marker fusion special effect of multiplayer interaction pops up in the virtual scenario. For example, when multiple players participate in the interaction “high five”, the marker fusion special effect is a dynamic effect showing that the action markers “palm” displayed around the multiple virtual objects converge and are then played. In some embodiments, after the marker fusion special effect is played, since the multiple players successfully participate in the interaction, a friend add control can pop up, or a friend add request can be automatically sent after successful interaction, to achieve effective social interactions at a deeper level.

Due to provision of an interaction mode based on an action marker in a virtual scenario, a player can perform a trigger operation on the action marker, such as tapping the action marker or approaching other players carrying the same action marker. This enables quick response to the interaction and realistically simulates an intuitive and natural real-person interaction mode in a real world, to promote the desire of the player for interaction, thus lowering an interaction operation barrier of the player, increasing the immersive feeling and sense of substitution of the player in social interaction, emphasizing the real-time nature and fun of a socializing mode based on interactions, promoting friendly interactions between teammates and even strangers, increasing the opportunity of establishing connections between the players, and improving the human-computer interaction efficiency and the gaming social experience.

The following describes a system architecture related to this application.

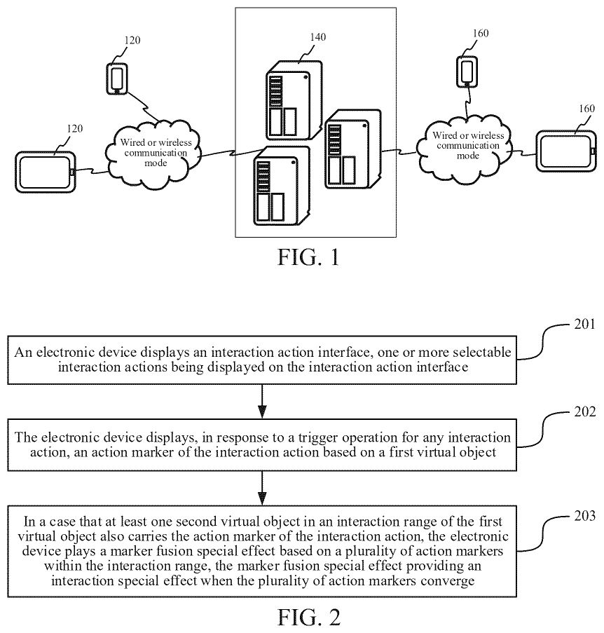

FIG. 1 is a schematic diagram of an implementation environment of an interaction method based on virtual objects according to an embodiment of this application. Referring to FIG. 1, the implementation environment includes: a first terminal 120, a server 140, and a second terminal 160.

An application program supporting a virtual scenario is installed and run on the first terminal 120. In some embodiments, the application program includes: any one of a multiplayer equipment survival game, an FPS game, a TPS game, an MOBA game, a virtual reality application program, or a three-dimensional map application program. In some embodiments, the first terminal 120 is a terminal used by a first user. When the first terminal 120 runs the application program, a user interface of the application program is displayed on a screen of the first terminal 120. Furthermore, based on a starting operation performed by the first user in the user interface, a virtual scenario is loaded and displayed in the application program. The first user uses the first terminal 120 to operate a first virtual object located in the virtual scenario to do activities which include but are not limited to: at least one of adjusting a body posture, crawling, walking, running, riding, jumping, driving, picking up, shooting, attacking, throwing, and fighting. Schematically, the first virtual object may be a first virtual person, such as a simulated character role or a cartoon character role.

The first terminal 120 and the second terminal 160 communicate directly or indirectly with the server 140 in a wired or wireless communication mode.

The server 140 includes at least one of one server, multiple servers, a cloud computing platform, or a virtualization center. The server 140 is configured to provide a backend service for an application program supporting a virtual scenario. In some embodiments, the server 140 undertakes primary computing work, and the first terminal 120 and the second terminal 160 undertake secondary computing work. Alternatively, the server 140 undertakes secondary computing work, and the first terminal 120 and the second terminal 160 undertake primary computing work. Alternatively, coordinated computing is performed among the server 140, the first terminal 120, and the second terminal 160 by using a distributed computing architecture.

In some embodiments, the server 140 may be an independent physical server, or a server cluster or a distributed system formed by multiple physical servers, or a cloud server that provides basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform.

An application program supporting a virtual scenario is installed and run on the second terminal 160. In some embodiments, the application program includes: any one of a multiplayer equipment survival game, an FPS game, a TPS game, an MOBA game, a virtual reality application program, or a three-dimensional map application program. In some embodiments, the second terminal 160 is a terminal used by a second user. When the second terminal 160 runs the application program, a user interface of the application program is displayed on a screen of the second terminal 160. Furthermore, based on a starting operation performed by the second user in the user interface, a virtual scenario is loaded and displayed in the application program. The second user uses the second terminal 160 to operate a second virtual object located in the virtual scenario to do activities which include but are not limited to: at least one of adjusting a body posture, crawling, walking, running, riding, jumping, driving, picking up, shooting, attacking, throwing, and fighting. Schematically, the second virtual object may be a second virtual person, such as a simulated character role or a cartoon character role.

In some embodiments, the first virtual object controlled by the first terminal 120 and the second virtual object controlled by the second terminal 160 are located in the same virtual scenario. In this case, the first virtual object can interact with the second virtual object in the virtual scenario.

In some embodiments, the first virtual object and the second virtual object are in an adversarial relationship. For example, the first virtual object and the second virtual object belong to different camps or teams. The virtual objects in the adversarial relationship can antagonistically interact on the land, such as releasing virtual skills, firing shooting props, or throwing out throwing props.

In some other embodiments, the first virtual object and the second virtual object are in a teammate relationship. For example, the first virtual object and the second virtual object belong to the same camp or the same team, and have a friend relationship with each other, or have a temporary communication permission.

In some embodiments, the application programs installed on the first terminal 120 and the second terminal 160 may be the same, or the application programs installed on the two terminals are the same type of application programs on different operating system platforms. The first terminal 120 and the second terminal 160 both generally refer to one of a plurality of terminals. The embodiment of this application is described by merely taking the first terminal 120 and the second terminal 160 as an example.

Device types of the first terminal 120 and the second terminal 160 are the same or different. The device type includes: at least one of a smartphone, a tablet computer, a smart sound box, a smart watch, a smart handheld console, a portable game device, an on board terminal, a laptop portable computer, or a desktop computer, and is not limited thereto. For example, both the first terminal 120 and the second terminal 160 are smartphones or other portable game devices. The following embodiments are described by using an example in which a terminal includes a smartphone.

A person skilled in the art can learn that a quantity of the foregoing terminals is more or less. For example, the foregoing terminal is only one, or the foregoing terminal is dozens or hundreds, or more. The embodiments of this application do not limit a number and device types of terminals.

The following describes a basic flow of the embodiments of this application.

FIG. 2 is a flowchart of an interaction method based on virtual objects according to an embodiment of this application. Referring to FIG. 2, this embodiment is performed by an electronic device. The electronic device may be provided as the first terminal 120, the second terminal 160, or the server 140 in the foregoing implementation environment. This embodiment includes operation 201 to operation 203 below:

201. The electronic device displays an interaction interface, one or more selectable interactions being displayed on the interaction interface.

A virtual object mainly controlled by a user through the electronic device is referred to as a first virtual object.

In an exemplary embodiment, the electronic device displays the interaction interface in response to a trigger operation for an interaction control. The interaction control is configured for opening the interaction interface, namely, the interaction control may be considered as an entry to the interaction interface.

The interaction interface is configured for providing the user with at least one interaction that can achieve multiplayer interaction with a second virtual object in a virtual scenario. The above-mentioned multiplayer interaction means an interaction mode that can be performed based on an interaction and participated by two or more virtual objects. The two or more virtual objects include the first virtual object and one or more second virtual objects. For example, after the first virtual object initiates an interaction, if it has been detected that at least one second virtual object makes response to the interaction (e.g. performing the same interaction), a marker fusion special effect is played.

In some embodiments, the user launches a game application on an electronic device, and loads and displays a virtual scenario through the game application, and the interaction control is displayed in the virtual scenario. In some embodiments, the above interaction control can be permanently displayed in the virtual scenario. To be specific, the interaction control is displayed by default in the virtual scenario. This facilitates the user to open the interaction interface at any time through the interaction control during gaming and enriches ways for the user to enter the interaction interface.

In some other embodiments, the interaction control may also be a user interface (UI) control that can be called and displayed only after the user performs a specific operation. To be specific, the interaction control is hidden by default. The interaction control can be called and displayed only after the user performs the specific operation. The specific operation may be tapping a specified region on a screen, performing a preset slide operation on the screen, shaking the electronic device to an extent, and the like. By setting the interaction control to be hidden by default and support calling for displaying, the interaction control can be avoided from blocking the virtual scenario and affecting the game experience of the user. In addition, the specific operation for calling the interaction control can be provided when the user has a social need based on the interaction, which facilitates social communications of the user.

In some other embodiments, the interaction control may also be a function button that is displayed only after the user opens a setting interface, or a menu option that can be displayed only when the user expands a menu bar in the virtual scenario. This also can avoid the interaction control from blocking the virtual scenario and affecting the game experience of the user. In addition, an access entry for the interaction interface can be provided when the user has a social need based on the interaction.

In some other embodiments, the user may personalize a display mode of the interaction control through the setting interface. For example, the user sets that the interaction control is displayed by default in the virtual scenario, or the user sets that the interaction control is hidden by default in the virtual scenario and can be opened through a specific operation or the menu bar or the setting interface, so that different users can customize the interaction control according to their operation habits. This embodiment of this application does not impose specific limitations on this.

In some embodiments, when the interaction control is displayed in the virtual scenario, the user can perform the trigger operation on the interaction control provided by the virtual scenario to open the interaction interface. In some embodiments, in addition to entering the interaction interface through the interaction control, the user may open the interaction interface in another way.

In some embodiments, the electronic device displays the interaction interface in response to a touchhold operation performed on the first virtual object. That is, the user can make a long press on the first virtual object to open the interaction interface.

In some other embodiments, the electronic device displays the interaction interface in response to a specific gesture in a virtual scenario where the first virtual object is located. That is, the user performs the specific gesture in the virtual scenario to directly call the interaction interface. The specific gesture may be tapping the screen twice with a finger joint within set time. This embodiment of this application does not impose specific limitations on this.

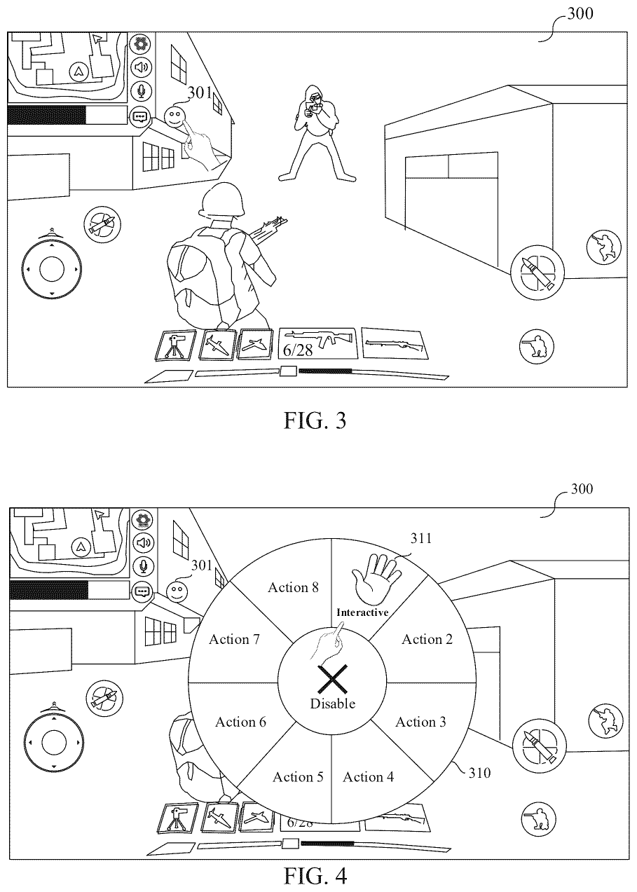

As shown in FIG. 3, an interaction control 301 is displayed in a virtual scenario 300 allowing free movement. The user can open the interaction interface in the virtual scenario 300 by tapping the interaction control 301. Schematically, if the interaction interface is referred to as an interaction wheel, the interaction control can be considered as an entry button of the interaction wheel.

In some embodiments, the above trigger operation for the interaction control includes but is not limited to: a tap operation, a double-tap operation, a press operation, a touchhold operation, a slide operation towards a specified direction, a voice instruction, a gesture instruction, and the like. This embodiment of this application does not impose specific limitations on the operation type of the trigger operation for the interaction control.

In some embodiments, a display mode of the interaction interface includes but is not limited to: pop-up window display, small window display, full screen display, sub-interface display, side expansion bar display, top drop-down bar display, bottom pull-up bar display, and the like. This embodiment of this application does not impose specific limitations on this.

In some embodiments, a visual interaction wheel is used in the interaction interface to display one or more interactions that can be selected by the first virtual object. The above one or more interactions may be configured by default by a system or personalized by the user through the setting interface. This embodiment of this application does not impose specific limitations on the configuration mode of the interactions displayed in the interaction wheel.

In some embodiments, the electronic device displays, in the interaction wheel, all interactions that can be initiated by the first virtual object. For example, the first virtual object only has a permission to initiate interactions that are unlocked by the first virtual object. Therefore, the electronic device determines all the interactions that are unlocked by the first virtual object and arranges them in an equal spacing in the interaction wheel, so that it is convenient for the user to select an action that the user intends to initiate from all the interactions.

In some other embodiments, the electronic device only displays, in the interaction wheel, some of the interactions that can be initiated by the first virtual object, such as displaying, in the interaction wheel, only K interactions with the highest sending frequencies, or displaying, in the interaction wheel, only interactions that are initiated K times recently, or displaying, in the interaction wheel, only K interactions personalized by the user, where K is an integer greater than or equal to 1, such as 5, 8, and 10.

In some embodiments, when the electronic device only displays, in the interaction wheel, some of the interactions that can be initiated by the first virtual object, the interaction wheel further provides an expansion button, which facilitates the user to perform a trigger operation on the expansion button when the user has found that no interactions that the user intends to initiate are displayed in the interaction wheel, so as to expand the other part of hidden interactions among all the interactions. This can avoid an excessively compact layout of the interaction wheel when there are many interactions unlocked by the first virtual object, thus optimizing the layout of the interaction wheel.

In some embodiments, when the electronic device only displays, in the interaction wheel, some of the interactions that can be initiated by the first virtual object, the user can slide the interaction wheel clockwise or counterclockwise to expand the other part of hidden interactions among all the interactions. This avoids provision of an explicit expansion button in the interaction wheel, and a slide operation in a specified direction is equivalent to a secondary confirmation operation, which can avoid an accidental touch on the expansion button and reduce a probability that the user accidentally taps to expand the hidden interactions.

As shown in FIG. 4, after the user taps the interaction control 301 based on FIG. 3, an interaction interface 310 will be displayed in the virtual scenario 300. The interaction interface 310 is provided as an interaction wheel. The interaction wheel is divided into a plurality of sector regions. Each sector region displays one selectable interaction.

202. The electronic device displays, in response to a trigger operation for any interaction, an action marker of the interaction associated with a first virtual object.

In some embodiments, when one or more selectable interactions are displayed on the interaction interface, the user can perform the trigger operation on any interaction on the interaction interface. In response to the trigger operation performed by the user on the any interaction, the electronic device displays the action marker of the interaction based on the first virtual object. The action marker is configured for uniquely indicating the interaction, namely, each interaction has a unique corresponding action marker. For example, the action marker is an identification pattern or identification emoji of the interaction. In an example, the identification emoji is provided as a three-dimensional UI emoji.

In some embodiments, the electronic device may display the action marker of the interaction within a target range of the first virtual object. The target range may be above the head of the first virtual object, on the left side of the first virtual object, on the right side of the first virtual object, under the feet, a designated body part, or a circle around the body. This embodiment of this application does not impose specific limitations on the target range. Using the target range to constrain a display position of the action marker of the interaction can intuitively reflect an association between the action marker of the interaction and the first virtual object. The display standardization of the action marker of the interaction is high, which is conducive to improving the visual experience of the user and thus improving the human-computer interaction rate.

In some other embodiments, the electronic device may also directly control the first virtual object to perform the interaction, and float (or display), after the performing of the interaction is completed, the action marker of the interaction within the target range of the first virtual object. This embodiment of this application does not impose specific limitations on the display mode of the action marker.

In some embodiments, the above trigger operation for the interaction includes but is not limited to: a tap operation, a double-tap operation, a press operation, a touchhold operation, a slide operation towards a specified direction, a voice instruction, a gesture instruction, and the like. This embodiment of this application does not impose specific limitations on the operation type of the trigger operation for the interaction.

In some embodiments, for the case that the one or more selectable interactions are displayed through the interaction wheel, and each sector region in the interaction wheel displays one selectable interaction, the trigger operation for any interaction may include but is not limited to: a tap operation for the sector region where any interaction is located in the interaction wheel; and a slide operation from a center region of the interaction wheel to the sector region where any interaction is located.

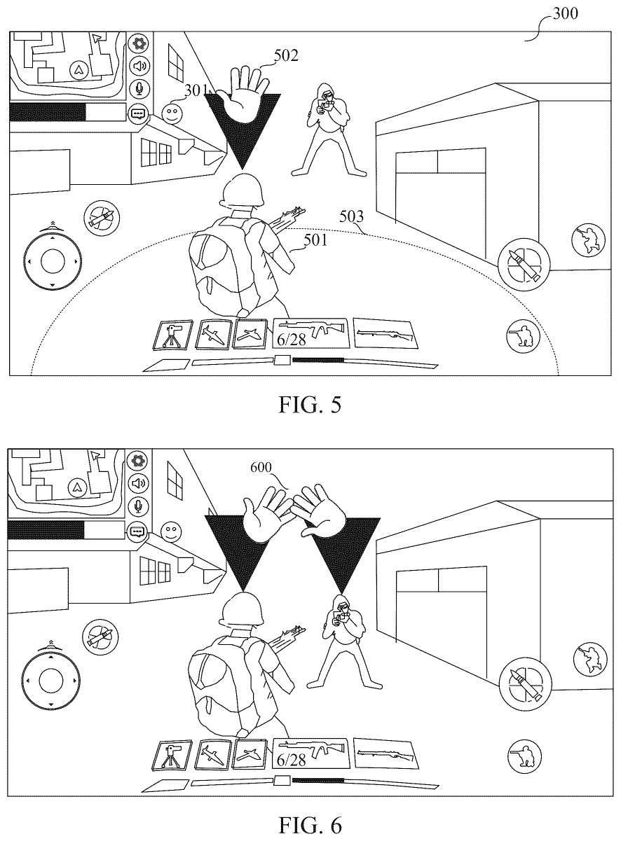

As shown in FIG. 5, the user can tap a “high five” interaction 311 provided in the interaction interface 310 based on FIG. 4, or slide from the center of the interaction wheel to the “high five” interaction 311, to perform a trigger operation on the “high five” interaction 311, and then enter an interface shown in FIG. 5. To be specific, in response to the trigger operation for the “high five” interaction 311, the interaction interface 310 is automatically hidden in the virtual scenario 300. Then, a “palm” action marker 502 of the “high five” interaction 311 is displayed above the head of the first virtual object 501. In this case, the first virtual object 501 enters an interactive state, and a round interaction range 503 (the interaction range is not drawn completely due to a limited field of view) is displayed under the feet of the first virtual object 501.

203. In a case that at least one second virtual object appears within an interaction range of the first virtual object and carries the action marker of the interaction, the electronic device plays a marker fusion special effect based on a plurality of action markers within the interaction range. The marker fusion special effect provides an interaction special effect when the plurality of action markers converge.

The plurality of action markers include the action marker displayed based on the first virtual object and the action marker carried by the at least one second virtual object in the interaction range.

In some embodiments, the electronic device may first determine the interaction range of the first virtual object; detect, in real time within the interaction range, whether there is a second virtual object carrying the action marker of the same interaction; according to the action marker carried by each detected second virtual object and the action marker of the first virtual object itself (there are at least two or more action markers in total), generate an interaction special effect, i.e. the marker fusion special effect, for indicating convergence of the two or more action markers; and then play the above generated marker fusion special effect.

For example, within the interaction range of the first virtual object, the electronic device counts a number of second virtual objects carrying the action marker of the same interaction, and generates a marker fusion special effect based on the action marker of the first virtual object itself and the action markers satisfying the number, thus playing the marker fusion special effect, so that the special effect intensity of the marker fusion special effect is in positive correlation with the number of the action markers participating in the convergence. In this way, it simulates an interaction mode in the real world where the more people participate, the more noticeable the interaction is, achieving a more realistic visual interaction effect, which is conducive to enhancing the interaction experience and increasing the human-computer interaction rate.

As shown in FIG. 6, when only one second virtual object carrying the same action marker is detected within the interaction range of the first virtual object, the action marker of the first virtual object and the action marker of the detected second virtual object converge, and a marker fusion special effect 600 when the two action markers converge is played. It can be seen that for the “palm” action marker of the “high five” interaction, the marker fusion special effect 600 can be implemented as follows: the two “palm” action markers gradually converge, and the “high five” interaction is performed.

According to the method provided by this embodiment of this application, by providing a quick interaction mode based on interactions, a user can control a first virtual object to initiate any interaction after opening an interaction interface through an interaction control, and combine and play a marker fusion special effect according to second virtual objects that initiate the same interaction within an interaction range of the first virtual object, to indicate that an action marker of the first virtual object and action markers of the second virtual objects converge through multiplayer interaction, thus displaying and providing a multiplayer social interaction form between two or more virtual objects, enriching the interaction modes based on the interactions, increasing a degree of integration with a virtual scenario, improving a real-time interaction feeling and immersive feeling, and improving the human-computer interaction efficiency.

All the foregoing exemplary technical solutions can be combined in different manners to form exemplary embodiments of the present disclosure, and details are not described herein.

The following describes a detailed flow in an embodiment of this application.

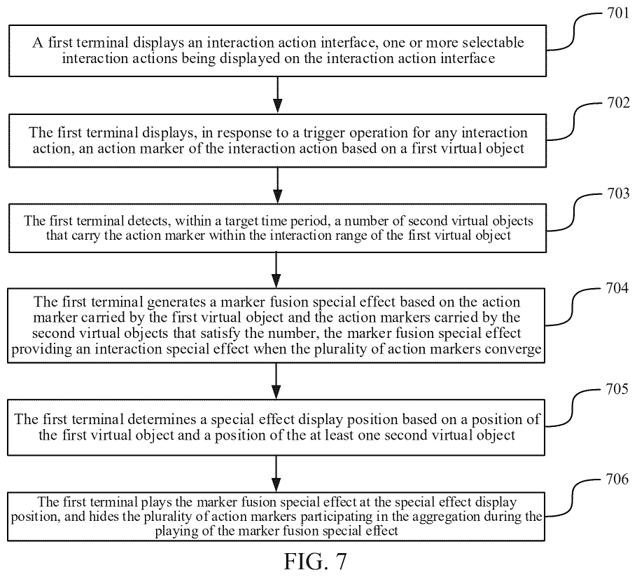

FIG. 7 is a flowchart of an interaction method based on virtual objects according to an embodiment of this application. Referring to FIG. 7, this embodiment is performed by an electronic device. The electronic device may be provided as the first terminal 120, the second terminal 160, or the server 140 in the foregoing implementation environment.

Next, the electronic device being the first terminal controlling a first virtual object will be taken as an example for description. Furthermore, for ease of distinction, an electronic device controlling a second virtual object may be referred to as the second terminal. This embodiment includes operation 701 to operation 706 below:

701. The first terminal displays an interaction interface, one or more selectable interactions being displayed on the interaction interface.

Operation 701 is the same as operation 201 in the previous embodiment. Details are not elaborated here.

Illustratively, the first terminal displays the interaction interface in response to a trigger operation for an interaction control. In some embodiments, the trigger operation being a tap operation is taken as an example for description. A processor of the first terminal detects, in real time, a tap gesture performed by a user on the interaction control. If it is detected that the user performs the tap gesture on the interaction control, the interaction interface is displayed in the virtual scenario.

As shown in FIG. 8, the processor can sense the tap gesture in real time on a touch screen through a touch sensor. If a touch point of the tap gesture falls within a display range of the interaction control, the interaction interface will be displayed in the virtual scenario. For example, the interaction interface is considered as an interaction wheel. The interaction wheel is considered to be in a folded state before the user taps the interaction control, and the interaction wheel is considered to be in an expanded state after the user taps the interaction control. One or more selectable interactions are displayed in the interaction wheel. The above interaction needs to be an action that has already been unlocked by the first virtual object. The first virtual object can unlock a new interaction by system rewarding, task distribution, automatic obtaining, purchasing from a mall, and the like. This embodiment of this application does not impose specific limitations on the unlocking mode of the interaction.

In some embodiments, the first terminal displays the interaction interface in response to a touchhold operation for the first virtual object. In some other embodiments, the first terminal displays the interaction interface in response to a specific gesture in a virtual scenario where the first virtual object is located. The specific gesture may be tapping a screen twice with a finger joint within set time. This embodiment of this application does not impose specific limitations on this.

702. The first terminal displays, in response to a trigger operation for any interaction, an action marker of the interaction associated with a first virtual object.

In some embodiments, when one or more selectable interactions are displayed on the interaction interface, the user can perform the trigger operation on any interaction on the interaction interface. In response to the trigger operation performed by the user on the any interaction, the first terminal displays the action marker of the interaction based on the first virtual object. The action marker is configured for uniquely indicating the interaction, namely, each interaction has a unique corresponding action marker. For example, the action marker is an identification pattern or identification emoji of the interaction. In an example, the identification emoji is provided as a three-dimensional UI emoji.

In some embodiments, the first terminal may display the action marker of the interaction within a target range of the first virtual object. The target range may be above the head of the first virtual object, on the left side of the first virtual object, on the right side of the first virtual object, under the feet, a designated body part, or a circle around the body. This embodiment of this application does not impose specific limitations on the target range.

In some other embodiments, the first terminal may also directly control the first virtual object to perform the interaction, and float, after the performing of the interaction is completed, the action marker of the interaction within the target range of the first virtual object. This embodiment of this application does not impose specific limitations on the display mode of the action marker.

In some embodiments, the above trigger operation for the interaction includes but is not limited to: a tap operation, a double-tap operation, a press operation, a touchhold operation, a slide operation towards a specified direction, a voice instruction, a gesture instruction, and the like. This embodiment of this application does not impose specific limitations on the operation type of the trigger operation for the interaction.

In some embodiments, for the case that the one or more selectable interactions are displayed through the interaction wheel, and each sector region in the interaction wheel displays one selectable interaction, the trigger operation for any interaction may include but is not limited to: a tap operation for the sector region where any interaction is located in the interaction wheel; and a slide operation from a center region of the interaction wheel to the sector region where any interaction is located.

The following will describe a possible implementation of how the first terminal displays the action marker within the target range. Referring to operation A1 to operation A3:

A1. The first terminal configures the first virtual object to be an interactive state in response to the trigger operation for any interaction.

In some embodiments, the trigger operation being a tap operation is taken as an example for description. The processor of the first terminal detects, in real time, a tap gesture performed by a user on the interaction interface. If it is detected that the user performs the tap gesture on the interaction interface, a display region of an interaction into which a touch point of the tap gesture specifically falls is then determined, so that the interaction indicated by the display region is determined to be an interaction selected by the trigger operation. For example, the tap gesture performed by the user on the interaction wheel is detected, and the interaction indicated by a sector region into which the touch point of the tap gesture falls is determined to be the interaction selected by the trigger operation.

In some other embodiments, the trigger operation being a slide operation from a center region of the interaction wheel to any sector region is taken as an example for description. The processor of the first terminal detects, in real time, a touchhold gesture performed on the interaction interface, initiates a touchstart event of the slide operation, and obtains screen coordinates (startX, startY) of a slide starting point of a finger in the touchstart event. If (startX, startY) are located in the interaction wheel and do not fall into any sector region of the interaction wheel, it represents that (startX, startY) have fallen into the center region of the interaction wheel, or it can directly determine whether (startX, startY) have fallen into the center region of the interaction wheel. In a case that (startX, startY) fall into the center region of the interaction wheel, when the user holds the touching and moves on the touch screen with the finger, the first terminal continuously detects a touchmove event, obtains touch coordinates of the finger at a current position, calculates coordinate differences (moveX, moveY) between the slide starting point and the current position. When the finger of the user leaves the touch screen, the first terminal determines that the touchmove event ends, namely, a touchend event of the slide operation has been detected. In this case, the processor obtains screen coordinates (endX, endY) of a slide end point of the latest position when the finger leaves the touch screen, and determines whether (endX, endY) fall into a coordinate range buttonRange of any sector region in the interaction wheel. If (endX, endY) fall into the buttonRange of any sector region, it represents that the slide operation from the center region of the interaction wheel to a sector region has been detected, thus determining the interaction indicated by the sector region to be the interaction selected by the trigger operation.

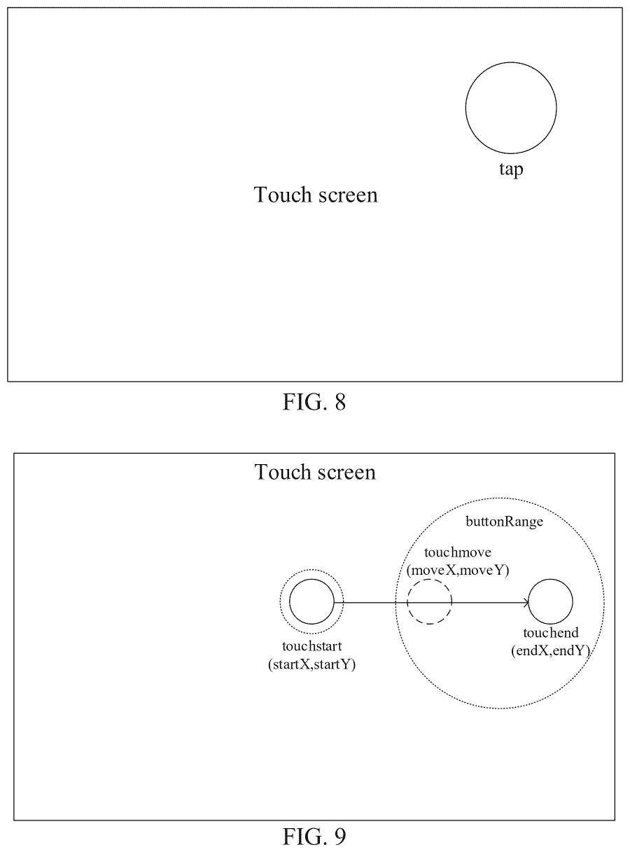

As shown in FIG. 9, the processor can sense, in real time through the touch sensor on the touch screen, the touchhold gesture performed by the user. If the touch point of the touchhold gesture falls into the center region of the interaction wheel, the touchstart event of the slide operation is activated, and the screen coordinates (startX, startY) of the slide starting point are recorded. When the user holds the touching and moves on the touch screen with the finger, the first terminal continuously detects the touchmove event and records coordinate differences (moveX, moveY) between a finger position of each frame and the slide starting point. When the finger of the user leaves the touch screen, the first terminal obtains the touchend event of the slide operation, records the screen coordinates (endX, endY) of the slide end point, and determines whether (endX, endY) fall into the coordinate range buttonRange of any sector region in the interaction wheel. If (endX, endY) fall into the buttonRange of any sector region, it represents that the slide operation from the center region of the interaction wheel to a sector region has been detected, thus determining the interaction indicated by the sector region to be the interaction selected by the trigger operation.

In addition, the above only provides two possible implementations of the trigger operation for the interaction, but the trigger operation for the interaction may also be provided as a voice instruction, a gesture instruction, and the like, which will not be specifically limited here.

In some embodiments, the first terminal records an action identification (ID) of the interaction in response to the trigger operation performed by the user on any interaction in the interaction interface, and updates an interaction attribute of the first virtual object. A process of updating the interaction attribute includes: the first virtual object is configured to be in an interactive state. For example, an interaction state parameter isActive of the first virtual object is initialized to True, so as to indicate, through the interaction state parameter isActive, whether the first virtual object is in an interactive state.

The interaction state parameter isActive is configured for indicating whether another virtual object can initiate interaction-action-based multiplayer interaction with the first virtual object. When a value of the interaction state parameter isActive is True, it represents that the another virtual object can initiate the interaction-action-based multiplayer interaction with the first virtual object, namely, the first virtual object is in an interactive state. Otherwise, when the value of the interaction state parameter isActive is False, it represents that the another virtual object cannot initiate the interaction-action-based multiplayer interaction with the first virtual object, namely, the first virtual object is in a non-interactive state.

In some other embodiments, the above process of updating the interaction attribute further includes: an interaction type parameter action is set to the interaction indicated by the action ID. For example, the interaction type parameter action is set to an interaction “high five”, or the interaction type parameter action may be directly set to an action ID of the interaction “high five”. There are no specific limitations on whether the interaction type parameter action records an action name or the action ID.

In some other embodiments, the above process of updating the interaction attribute further includes: an interaction range of the first virtual object is configured. For example, the interaction range activeRange of the first virtual object is initialized to be a circular region using the first virtual object as a circle center and using a fixed value as a radius. The fixed value is a value that is greater than 0 and defined by a technician in advance. For example, the fixed value is 5 meters and 10 meters under a scale of the virtual scenario. This embodiment of this application does not impose specific limitations on this. The interaction range activeRange will be configured for detecting a second virtual object in next operation 703, and will not be elaborated here.

A2. The first terminal sets an active time period for the action marker of the interaction for the first virtual object that is in the interactive state.

In some embodiments, for the first virtual object with the interaction state parameter isActive having the value of True, the first terminal configures the active time period active Time for the action marker of the interaction. The active time period activeTime may be implemented as an absolute time period determined by a start moment and an end moment, or the active time period activeTime may also be implemented as a timing time period starting from a starting point of timing. According to different timing types, the timing time period may be divided into a count-up time period and a countdown time period. Meanwhile, a timing duration needs to be specified. For example, the timing duration is a value that is greater than 0 and defined by a technician in advance, such as 30 seconds or 60 seconds. This embodiment of this application does not impose specific limitations on this.

In some embodiments, the active time period activeTime being a countdown time period lasting for 30 seconds is taken as an example for description. The first terminal may set an initial value for the active time period activeTime and start to count down for 30 seconds.

A3. The first terminal displays the action marker of the interaction within the target range of the first virtual object within the active time period.

In some embodiments, the first terminal can determine whether a current moment is within the active time period. If the current moment is within the active time period, the action marker of the interaction is displayed within the target range of the first virtual object. Otherwise, if the current moment is not within the active time period, the first terminal may not display the action marker of the interaction. For example, after the active time period ends, the displaying of the action marker of the interaction is canceled, or the action marker of the interaction is hidden or removed.

In some embodiments, the active time period activeTime being a countdown time period lasting for 30 seconds is taken as an example for description. The first terminal will automatically decrease activeTime by one every second. In this way, it is only necessary to determine whether activeTime is greater than 0 at each moment to determine whether the current moment is within the active time period. To be specific, when activeTime>0, the current moment is within the active time period. According to the interaction type parameter action, a display resource of the action marker of the interaction is found in a cache, and the action marker of the interaction is drawn to the target range of the first virtual object according to the display resource. For example, when the target range is above the head, the action marker is drawn to above the head of the first virtual object. When activeTime≤0, if the current moment is not within the active time period, it indicates that the interactive state of the first virtual object has ended. Therefore, the interaction state parameter isActive of the first virtual object needs to be set to False, and the displaying of the action marker of the interaction displayed within the target range of the first virtual object needs to be canceled, or the action marker needs to be hidden or removed. For example, when the target range is above the head, the action marker displayed at above the head of the first virtual object is hidden.

In operation A1 to operation A3 above, a possible implementation of displaying the action marker of the interaction within the target range of the first virtual object is provided. By configuring the interaction attribute for the first virtual object, one or more of the interaction state parameter isActive, the active time period activeTime, the interaction range activeRange, and the interaction type parameter action can be configured, thus facilitating execution of a display logic of the action marker and execution of a detection logic of a second virtual object.

In the process of displaying the action marker of the interaction within the target range, the active time period of the action marker is also considered, which is conducive to further improving the display standardization of the action marker, avoiding the confusion of a display page caused by long display time of the action marker, enhancing the visual effect, and then increasing the human-computer interaction rate.

In some embodiments, in response to the trigger operation performed by the user on any interaction on the interaction interface, the first terminal further sends an interaction request to the server in addition to configuring the interaction attribute for the first virtual object. The interaction request carries the above configured interaction state parameter isActive, active time period activeTime, interaction range activeRange, and interaction type parameter action, so that the server records the above interaction attributes in response to the interaction request, and has detected other virtual objects with fields of view where the first virtual object can be observed. However, the fact that the first virtual object is located within the fields of view of the other virtual objects does not mean that the virtual objects fall within the interaction range activeRange of the first virtual object, but only represents that the first virtual object and the action marker carried by the first virtual object can be observed from main viewing angles of the other virtual objects (but only other virtual objects located within the interaction range activeRange of the first virtual object can operate the action marker). Therefore, the other virtual objects may not necessarily be second virtual objects. Then, the server synchronizes the interaction request to other terminals that control the above other virtual objects.

In some other embodiments, the first terminal may also directly send an interaction request to the server in response to the trigger operation performed by the user on any interaction on the interaction interface. The interaction request only carries a timestamp of the trigger operation, so that the server configures the interaction state parameter isActive, the active time period activeTime, the interaction range activeRange, and the interaction type parameter action for the first virtual object in response to the interaction request, and has detected other virtual objects with fields of view where the first virtual object can be observed. The interaction request is synchronized to other terminals that control the above other virtual objects.

In the above process, by synchronizing the interaction request, it is convenient for other terminals that control other virtual objects to display the action marker within the target range of the first virtual object in response to the interaction request, thus ensuring that the interaction initiated by the first virtual object in a game is synchronized to other terminals whose fields of view cover the first virtual object.

This embodiment of this application does not impose specific limitations on whether the configuration process of the interaction attributes is synchronized to the server and other terminals after being implemented locally on the first terminal, or is issued to the first terminal and other terminals after being implemented in a cloud of the server. The former can reduce the latency of displaying the action marker on the first terminal and avoid the impact of network fluctuations on the display process of the action marker, and the latter can ensure that times for different terminals to display the action marker of the first virtual object in a game are almost synchronized.

In some embodiments, for other virtual objects whose fields of view cover the first virtual object, there are two following modes to participate in the multiplayer interaction with the first virtual object, which will be described respectively below.

Mode I: making a response to the action marker carried by the first virtual object.

In some embodiments, after the first virtual object initiates the interaction, another terminal where another virtual object is located will display an action marker within the target range of the first virtual object. Furthermore, in a case of detecting that the another virtual object is located within the interaction range activeRange of the first virtual object, the action marker displayed within the target range of the first virtual object may be configured to be in an interactive state. In this way, it is equivalent that if the first virtual object is located within the field of view of the another virtual object, but the another virtual object does not enter the interaction range activeRange of the first virtual object, the action marker displayed within the target range of the first virtual object is still in a non-interactive state, and the another user can control the another virtual object to approach the first virtual object until the another virtual object enters the interaction range activeRange of the first virtual object. In this way, the action marker switches from the non-interactive state to the interactive state. Thus, the another user can make response to the interaction initiated by the first virtual object by performing the trigger operation on the action marker carried by the first virtual object, namely, causing the another virtual object to perform the same interaction as the first virtual object. Furthermore, based on operation A1 to operation A3, the action marker of the interaction is also displayed within the target range of the another virtual object in the same way.

In this case, since the other virtual objects trigger the execution of the same interaction as the first virtual object through Mode I, the first virtual object and the another virtual object carry the same action marker. Thus, the another virtual object may be detected to be a second virtual object in operation 703 below. In other words, the second virtual object is caused to also carry the action marker by performing a trigger operation on the action marker of the first virtual object.

For example, the trigger operation performed on the action marker of the first virtual object being a tap operation is taken as an example for description. A processor of another terminal detects, in real time, a tap gesture performed by the user on the action marker carried by the first virtual object. If the user performs the tap gesture on the action marker carried by the first virtual object and the action marker is currently in an interactive state, the processor controls another virtual object to perform the same interaction as the first virtual object, configures the interaction state parameter isActive of the another virtual object to True, synchronizes the interaction type parameter action to be the interaction of the first virtual object, and also displays the action marker of the interaction within the target range of the another virtual object.

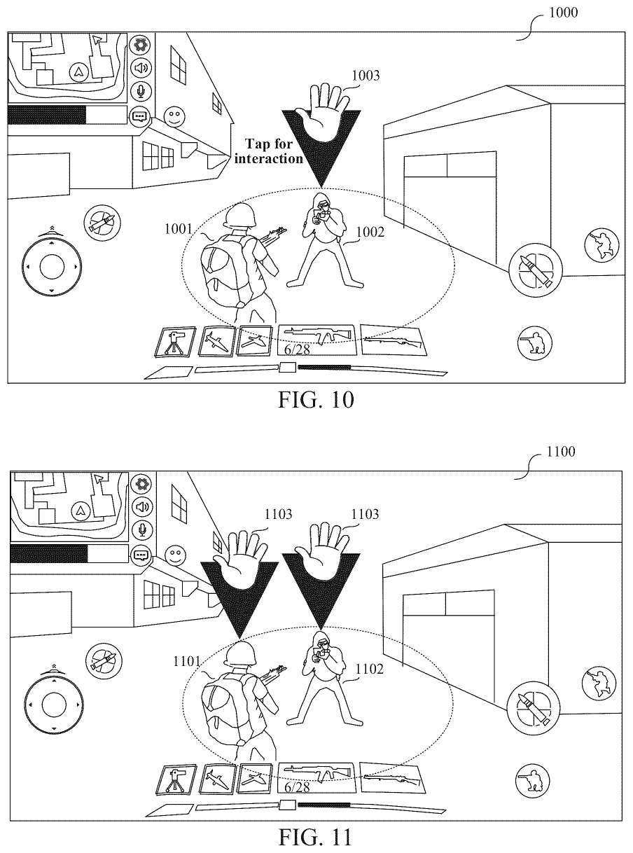

As shown in FIG. 10, the target range being above the head of the first virtual object is taken as an example for description. A virtual scenario 1000 in a viewing angle of another virtual object is shown. In the virtual scenario 1000, another virtual object 1001 and a first virtual object 1002 are displayed. The viewing angle of the another virtual object 1001 is a main viewing angle of another terminal. In an active time period activeTime (i.e., limited time when the first virtual object 1002 is in an interactive state), an action marker 1003 displayed above the head of the first virtual object 1002 can be observed in the viewing angle of the another virtual object 1001. In this case, since the another virtual object 1001 is located within the interaction range activeRange (circular region) of the first virtual object 1002, the action marker 1003 carried by the first virtual object 1002 is configured to be in an interactive state. Another user can make response to the interaction initiated by the first virtual object 1002 by performing a trigger operation on the action marker 1003 carried by the first virtual object 1002, thus achieving an interaction mode of “one party initiates an action, and another party responds the action”. For example, the another user can directly make response to the interaction initiated by the first virtual object 1002 by tapping the action marker 1003 carried by the first virtual object 1002, to control the another virtual object 1001 to also perform the interaction “high five”. Based on operation A1 to operation A3, the same action marker “palm” (not shown in FIG. 10) may also be displayed above the head of the another virtual object in the same way 1001.

In addition, when the action marker is displayed for the first virtual object on the another terminal, interaction prompt information for the action marker may be displayed. For example, in FIG. 10, when the action marker 1003 carried by the first virtual object 1002 is displayed, interaction prompt information “Tap for interaction” is also displayed, which facilitates prompting the another virtual object 1001 on how to participate in the multiplayer interaction, thus lowering an operation barrier and reducing the operation costs of the user.

Mode II: two parties approaching after initiating the same interaction.

In some other embodiments, after the first virtual object initiates the interaction, it is assumed that another user also has controlled another virtual object to initiate the same interaction, and the first virtual object and the another virtual object gradually approach each other until the another virtual object walks into the interaction range activeRange of the first virtual object, or until the first virtual object walks into the interaction range activeRange of the another virtual object. In this way, a distance between the first virtual object and the another virtual object is less than a radius of the interaction range activeRange, which may trigger initiation of multiplayer interaction.

In this way, since the another virtual object initiates, by itself, the same interaction as the first virtual object in the same way as the first virtual object, it naturally ensures that the another virtual object carries the same action marker as the first virtual object. Therefore, the another virtual object may be detected as the second virtual object in operation 703. That is, the another virtual object participates in the multiplayer interaction through Mode II.

As shown in FIG. 11, the target range being above the head of the first virtual object is taken as an example. A virtual scenario 1100 in a viewing angle of another virtual object is shown. In the virtual scenario 1100, another virtual object 1101 and a first virtual object 1102 are displayed. A viewing angle of the another virtual object 1101 is a main viewing angle of another terminal. The first virtual object 1102 initiates an interaction “high five” by itself, so an action marker 1103 “palm” is displayed above the head of the first virtual object 1102. Similarly, the another virtual object 1101 also initiates the interaction “high five” by itself, so the same action marker 1103 “palm” may be displayed above the head of the another virtual object 1101 too. To be specific, when the another virtual object 1101 and the first virtual object 1102 carry the same action marker, and the two parties approach each other until a distance between them is less than the radius of the interaction range activeRange, it indicates that the two parties are located within the interaction ranges activeRange of each other. This will automatically trigger responses to the actions initiated by the two parties, and the two parties will participate in the multiplayer interaction. This achieves an interaction mode of “Two parties approach each other after initiating an interaction”. For example, when a user and another user both tap an interaction “high five” in the interaction wheel to initiate interaction and control the another virtual object 1101 and the first virtual object 1102 to move freely in the virtual scenario, if a distance between the two parties is less than the radius of the interaction range activeRange at a certain moment within an intersection of the active time periods of the action markers of the two parties, the another virtual object 1101 may be automatically detected to be the second virtual object through operation 703 below, and the two parties are automatically triggered to participate in the multiplayer interaction.

703. The first terminal detects, within a target time period, a number of second virtual objects that carry the action marker within the interaction range of the first virtual object.

The target time period is a timing time period, and the target time period is falls within the active time period activeTime mentioned in operation A2. That is, the target time period is actually a subset of the active time period activeTime. To be specific, the first terminal does not count the second virtual object throughout the entire cycle of the active time period activeTime, but only counts the second virtual object within the target time period, settles multiplayer interaction once for the second virtual object that has been counted once, and generates a marker fusion special effect.

In some embodiments, a plurality of target time periods may be involved within the active time period activeTime, and the target time periods have the same counting modes. In this way, settlement of multiple rounds of multiplayer interactions can be initiated within the active time period activeTime, and the interaction efficiency based on interactions is improved. The multiple counting modes are the same. A single counting mode is taken as an example here for description and will not be elaborated.

In some embodiments, the target time period uses a moment when a second virtual object that carries the action marker has been detected for the first time within the interaction range as a starting point of timing, and the target time period lasts for a target duration from the starting point of timing. The target duration is any value that is greater than 0 and set by a technician in advance. For example, the target duration is 1 second. The target time period may be a count-up time period of up to 1 second from the starting point of timing, or may be a countdown time period of 1 second from the starting point of timing. This embodiment of this application does not impose specific limitations on this. In this case, the first terminal executes operation B1 to operation B3 below:

B1. The first terminal detects, within an active time period of the action marker of the first virtual object, a second virtual object that carries the action marker within the interaction range.

In some embodiments, within the active time period activeTime of the action marker of the first virtual object, the first terminal continuously detects, within the interaction range activeRange of the first virtual object, whether there is another virtual object that makes response through Mode I or that initiates the same interaction through Mode II. If any another virtual object that satisfies Mode I or Mode II has been detected, the another virtual object is determined to be a second virtual object.

B2. By using the moment when the second virtual object that carries the action marker has been detected for the first time as the starting point of timing, within the target duration after the starting point of timing, the first terminal adds detected second virtual objects that carry the action marker into an interaction list.

In some embodiments, when the second virtual object that carries the action marker has been detected for the first time, the moment of detection is used as the starting point of timing, and timing starts at the starting point of timing until the timing lasts for the target duration, thus determining a target time period. Then, the second virtual objects detected within the target time period are counted and are added into the interaction list.

For example, the target time period being a countdown time period of 1 second from the starting point of timing is taken as an example. It is assumed that the second virtual object that has been detected for the first time participates in the multiplayer interaction through Mode I. In this case, after any other user taps the action marker carried by the first virtual object displayed on another terminal, the another terminal sends an interaction response to the interaction request of the first terminal to the server, so that the server starts to count down for the target time period of 1 second, and creates an interaction list. The interaction list records object IDs of the second virtual objects that initiate the above interaction response, and other second virtual objects that are located within the interaction range activeRange of the first virtual object and initiate the interaction response or have already initiated the same interaction within the countdown target time period of 1 second (meaning that the interaction state parameters isActive is True and the interaction type parameters action is the same) are counted. The object IDs of the counted second virtual objects are added into the interaction list.

For another example, the target time period being a countdown time period of 1 second from the starting point of timing is taken as an example. It is assumed that the second virtual object that has been detected for the first time participates in the multiplayer interaction through Mode II. In this case, since another user itself controls the second virtual object to perform the same interaction as the first virtual object and controls the second virtual object to walk into the interaction range activeRange of the first virtual object, there inevitably is a second virtual object in an interactive state for the same interaction (meaning that the interaction state parameter isActive is True and the interaction type parameter action is the same). In this case, the another user does not need to make response by tapping the action marker carried by the first virtual object again, but the server starts to count down for the target time period of 1 second and creates an interaction list. The interaction list records object IDs of the above second virtual objects, and other second virtual objects that are located within the interaction range activeRange of the first virtual object and initiate the interaction response or have already initiated the same interaction within the countdown target time period of 1 second are counted. The object IDs of the counted second virtual objects are added into the interaction list.

B3. The first terminal determines a list length of the interaction list to be the number.

In some embodiments, after the timing within the target time period is completed, the first terminal will obtain a count-completed interaction list and determine a list length of the interaction list to be the number of the currently counted second virtual objects that carry the action marker within the interaction range of the first virtual object. The interaction list at least records an object ID of one second virtual object.

In operation B1 to operation B3 above, based on the situation of simultaneously supporting two modes for participating in the multiplayer interaction, how to count the number of the second virtual objects that carry the action marker within the interaction range within the target time period is provided, which can more comprehensively count all second virtual objects that can participate in the multiplayer interaction. In some embodiments, if only Mode I is supported to make response, it is possible to count only the second virtual objects that participate in the multiplayer interaction through Mode I. If only Mode II is supported to participate in the multiplayer interaction, it is possible to count only the second virtual objects that participate in the multiplayer interaction through Mode II. This embodiment of this application does not impose specific limitations on this.

704. The first terminal generates a marker fusion special effect based on the action marker carried by the first virtual object and the action markers carried by the second virtual objects that satisfy the number. The marker fusion special effect provides an interaction special effect when the plurality of action markers converge.

In some embodiments, since the first virtual object carries an action marker itself, and at least one action marker carried by at least one second virtual object will be counted in operation 703, a total of at least two action markers will participate in the generation process of the marker fusion special effect. The at least two action markers are the “plurality of action markers” involved in the marker fusion special effect, and the marker fusion special effect can provide an interaction special effect when the plurality of action markers converge.

In some embodiments, the first terminal may generate, based on the plurality of action markers and display positions of the plurality of action markers, a marker fusion special effect of converging the plurality of action markers from the respective display positions to a specified position.

In some other embodiments, a special effect intensity of the marker fusion special effect is in positive correlation with a number of the plurality of action markers. To be specific, as the number of the plurality of action markers increases, in addition to an increasing number of the action markers that participate in the convergence in the marker fusion special effect, additional special effect elements will be added too, such as adding a convergence special effect corresponding to the interactions. For example, when a plurality of action markers “palm” converge to form the marker fusion special effect “high five”, as the number of “palms” participating in the convergence increases, a “high five” ripple displayed on the marker fusion special effect is enlarged.

FIG. 6 is still taken as an example. The marker fusion special effect 600 shown in FIG. 6 is implemented as follows: two “palm” action markers gradually converge, and a “high five” interaction is performed. In this way, a number of action markers participating in the convergence is 2, and no “high five” ripple is displayed.

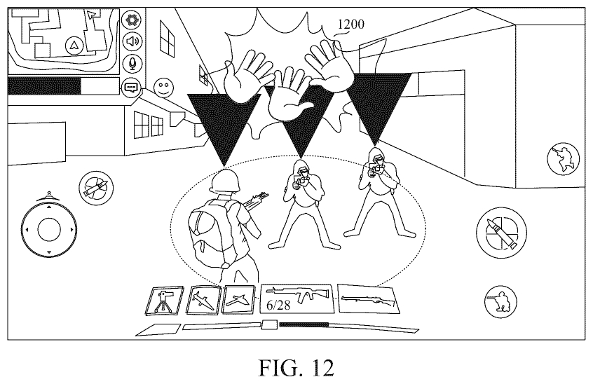

As shown in FIG. 12, a marker fusion special effect 1200 shown in FIG. 12 is implemented as follows: three “palm” action markers gradually converge, and a “high five” interaction is performed. In this way, a number of action markers participating in the convergence is 3. In addition to an increasing number of “palms”, a “high five” ripple effect is additionally added, thus achieving that the special effect intensity of the marker fusion special effect is in positive correlation with the number of the action markers.

In operation 703 to operation 704 above, a possible implementation for generating the marker fusion special effect based on the plurality of action markers within the interaction range is provided. Here, generation of a marker fusion special effect after count is completed within a single target time period is taken as an example. However, the active time period activeTime when the first virtual object is in the interactive state can be divided into a plurality of target time periods, and the count mode for each target time period is the same as that for the single target time period. In this way, settlement of multiple rounds of multiplayer interactions can be initiated within the active time period activeTime, and the interaction efficiency based on interactions is improved.

In some embodiments, in addition to the implementation described in operation 703 to operation 704 above, there are other implementations for the operation of generating the marker fusion special effect based on the plurality of action markers within the interaction range. For example, a total number of the plurality of action markers within the interaction range is counted, and the marker fusion special effect corresponding to the type of the currently displayed action markers and the total number is generated. The type of the action markers, the number of the action markers, and generation data of the marker fusion special effect can be correspondingly stored in the first terminal, so that the first terminal can extract the generation data of the corresponding marker fusion special effect according to the type and total number of the currently displayed action markers, and then use the generation data to generate the marker fusion special effect. The type of the action markers, the number of the action markers, and the generation data of the marker fusion special effect may be set by a technician in advance, or may be flexibly adjusted according to changes of the virtual scenario. The embodiment of this application does not impose limitations on this.

705. The first terminal determines a special effect display position based on a position of the first virtual object and a position of the at least one second virtual object.

In some embodiments, if a number of the second virtual object is one, namely, if only one second virtual object has been detected, the first terminal may determine a line segment composed of the position of the first virtual object and the position of the second virtual object, and determine the special effect display position based on a midpoint of the line segment. Illustratively, the first terminal may directly use the midpoint of the line segment composed of the position of the first virtual object and the position of the second virtual object as the special effect display position, or may use a position, which is perpendicular to the line segment and is at a first distance from the midpoint, as the special effect display position. The first distance is a distance greater than 0, and the first distance is set based on experience or flexibly adjusted according to the changes of the virtual scenario. This embodiment of this application does not impose limitations on this.

In some other embodiments, if a number of the second virtual object is a plurality, namely, if a plurality of second virtual objects have been detected, the first terminal may determine a position of the first virtual object and positions of the second virtual objects, thus determining a polygon using the positions of the virtual objects as vertexes, and determining the special effect display position based on a geometric center of the polygon. Illustratively, the first terminal may directly use the geometric center of the polygon as the special effect display position, or the first terminal may use a position, which is perpendicular to a first line segment and is at a second distance from the geometric center, as the special effect display position. The first line segment is a connecting line between the geometric center and the position of the first virtual object, and the second distance is a distance greater than 0. The second distance is set based on experience or flexibly adjusted according to the changes of the virtual scenario. This embodiment of this application does not impose limitations on this.

In some other embodiments, the first terminal may also directly use a center of a screen as the special effect display position. Alternatively, the position of the first virtual object may be used as the special effect display position. This embodiment of this application does not impose specific limitations on the determining mode of the special effect display position.

706. The first terminal plays the marker fusion special effect at the special effect display position, and hides the plurality of action markers participating in the convergence during the playing of the marker fusion special effect.

In some embodiments, the first terminal plays the marker fusion special effect generated in operation 704 at the special effect display position determined in operation 705. Since the marker fusion special effect usually has a set playing duration, when the marker fusion special effect is played for the playing duration, the displaying of the marker fusion special effect is canceled, and an effect that the marker fusion special effect automatically ends after a period of time is achieved.

In some embodiments, by hiding the plurality of action markers participating in the convergence during the playing of the marker fusion special effect, blockage of scenario elements caused by the displaying of many action markers in the virtual scenario during the playing of the marker fusion special effect can be avoided. Correspondingly, after the playing of the marker fusion special effect is completed, the displaying of the plurality of hidden action markers can be restored, which facilitates initiation of a next round of multiplayer interaction at any time within the active time period activeTime.

In operation 703 to operation 706 above, a possible implementation is provided: when at least one second virtual object in the interaction range of the first virtual object also carries the action marker of the interaction, the marker fusion special effect is played based on the plurality of action markers within the interaction range. In some other embodiments, the generation process of the marker fusion special effect and the determination process of the special effect display position are both calculated by the server, and the special effect display position and the marker fusion special effect are distributed to the first terminal and the second terminals participating in the convergence. In this way, each terminal directly obtains the special effect display position and marker fusion special effect distributed by the server, and displays the marker fusion special effect at the specified special effect display position.

In some other embodiments, since virtual objects at different viewing angles are at different positions, it is possible that only the generation process of the marker fusion special effect is generated on the server side, and the special effect display position is determined locally by the first terminal. Alternatively, to ensure absolute position consistency of the special effect display position in the virtual scenario, it is possible that only the determination process of the special effect display position is calculated on the server side, and the generation of the marker fusion special effect is completed locally on the first terminal. This embodiment of this application does not impose specific limitations on this.

In some embodiments, after the marker fusion special effect is played, the method further includes: if the first virtual object and any second virtual object within the interaction range are in a non-friend relationship, a friend add control for the any second virtual object pops up, or a friend add request is sent to the any second virtual object; and if the first virtual object and any second virtual object are in a friend relationship, a virtual intimacy between the first virtual object and the any second virtual object is increased. This mode can achieve social interaction at a deeper level between virtual objects based on interactions, which is conducive to improving the convenience of social interactions of the players and thus increasing the human-computer interaction rate.

To be specific, after each round of multiplayer interaction is completed, the friend add control may pop up on this basis, or after an interaction is successful, the friend add request may be automatically sent to other players participating in the interaction, so as to achieve effective social interactions at a deeper lever and increase social contacts between unfamiliar players. For two players who have been already friends, if they participate in a round of multiplayer interaction, there is no need to pop up the friend add control, and the virtual intimacy between two virtual objects controlled by the two players can be automatically increased.

According to the method provided by this embodiment of this application, by providing a quick interaction mode based on interactions, a user can control a first virtual object to initiate any interaction after opening an interaction interface through an interaction control, and combine and play a marker fusion special effect according to second virtual objects that initiate the same interaction within an interaction range of the first virtual object, to indicate that an action marker of the first virtual object and action markers of the second virtual objects converge through multiplayer interaction, thus displaying and providing a multiplayer social interaction form between two or more virtual objects, enriching the interaction modes based on the interactions, increasing a degree of integration with a virtual scenario, improving a real-time interaction feeling and immersive feeling, and improving the human-computer interaction efficiency.

In addition, using the target range to constrain a display position of the action marker of the interaction can intuitively reflect an association between the action marker of the interaction and the first virtual object. The display standardization of the action marker of the interaction is high, which is conducive to improving the visual experience of the user and thus improving the human-computer interaction rate. In the process of displaying the action marker of the interaction within the target range, the active time period of the action marker is also considered, which is conducive to further improving the display standardization of the action marker, avoiding the confusion of a display page caused by long display time of the action marker, enhancing the visual effect, and then increasing the human-computer interaction rate.

The special effect intensity of the marker fusion special effect is in positive correlation with the number of the action markers participating in the convergence. This simulates an interaction mode in the real world that if there are more players participating in the interaction, the interaction is more significant, achieving a more realistic visual interaction effect, which is conducive to enhancing the interaction experience and increasing the human-computer interaction rate. After the playing of the marker fusion special effect is completed, the displaying of the plurality of hidden action markers can be restored, which facilitates initiation of a next round of multiplayer interaction at any time within the active time period.

After each round of multiplayer interaction, a friend add control may pop up on this basis, the friend add request may be automatically sent to other players participating in the interaction, and the virtual intimacy between two virtual objects controlled by two players may be increased. This can achieve social interactions at a deeper lever between virtual objects based on interactions and is conductive to improving the convenience of social interactions of the players and then increasing the human-computer interaction rate.

All the foregoing exemplary technical solutions can be combined in different manners to form exemplary embodiments of the present disclosure, and details are not described herein.

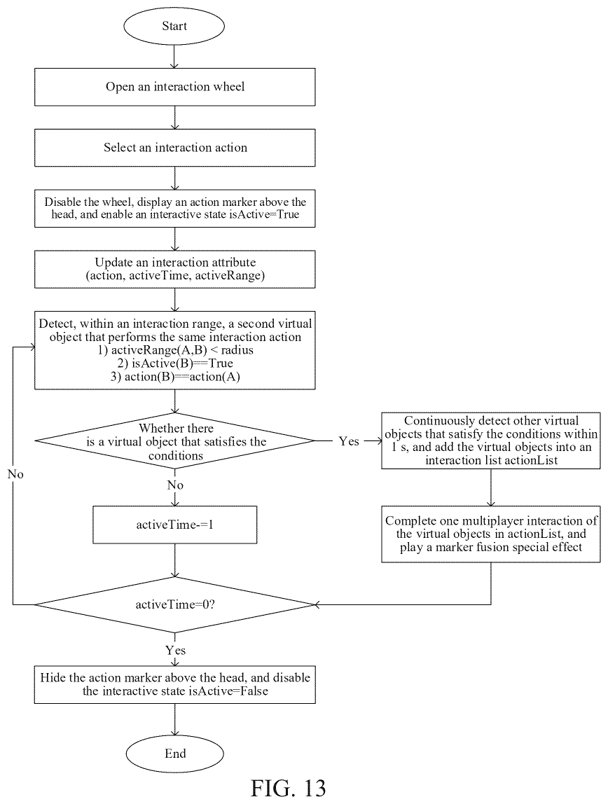

FIG. 13 is a schematic flowchart of an interaction method based on virtual objects according to an embodiment of this application. Referring to FIG. 13, this embodiment is performed by an electronic device. The electronic device being a first terminal is taken as an example for description. This embodiment includes 11 operations below:

Operation 1. The first terminal opens an interaction interface. For example, the interaction interface is provided as an interaction wheel. A first user can open the interaction wheel through an interaction control.

Operation 2. The first user selects an interaction on the interaction interface on the first terminal.

Operation 3. A target range being above the head is taken as an example. The first terminal closes the interaction interface (i.e., closes the interaction wheel), displays an action marker of the interaction above the head of a first virtual object, enables an interactive state for the first virtual object, and sets an interaction state parameter isActive=True.

Operation 4. The first terminal updates an interaction attribute of the first virtual object, such as an active time period activeTime, an interaction range activeRange, and an interaction type parameter action.

Operation 5. The first terminal detects, within the interaction range activeRange of the first virtual object, a second virtual object that performs the same interaction.

The second virtual object may participate in multiplayer interaction by tapping the action marker carried by the first virtual object (Mode I), or it is also possible that after a second user opens the interaction wheel on a second terminal and select the same interaction, the second user controls the second virtual object to move into the interaction range activeRange of the first virtual object to participate in multiplayer interaction (Mode II).

It is finally detected that first virtual object A and each second virtual object B satisfy the following conditions: 1) activeRange (A, B)<a radius of activeRange, meaning that a distance between A and B is less than the radius of activeRange, and the radius is a value preset by a technician in advance; 2) IsActive (B)==True, which means that a value of the interaction state parameter isActive of B is True; and 3) action (B)==action (A), which means that interaction type parameters of A and B are the same, indicating the same interaction.

Operation 6. The first terminal determines whether there is a second virtual object that satisfies both condition 1) to condition 3) in operation 5 above. If there is a second virtual object that satisfies the conditions, operation 7 to operation 8 are executed. If there is no second virtual object that satisfies the conditions, operation 9 is executed.

Operation 7. A target time period being 1-second countdown starting from time when a second virtual object has been detected for the first time is taken as an example. The first terminal continuously detects other second virtual objects that satisfy the above conditions within 1 second, and adds the second virtual objects detected within 1 second to an interaction list actionList.

Operation 8. The first terminal generates a marker fusion special effect between an action marker of the first virtual object and action markers of the second virtual objects in the interaction list actionList, and completes playing of the marker fusion special effect, thus completing one multiplayer interaction of the virtual objects in actionList.

For example, the first terminal obtains and calculates position coordinates of the action marker above the head of the first virtual object and position coordinates of the action markers above the heads of the second virtual objects, generates coordinates of an convergence point, controls the action markers to move from their own position coordinates to the coordinates of the convergence point, finally plays the marker fusion special effect of the action markers that complete the convergence at the coordinates of the convergence point, and determines, according to the number of the action markers participating in the convergence, whether additional elements that reflect the special effect intensity of the special effect need to be added.

Operation 9. An active time period being a countdown time period is taken as an example. The first terminal decreases the active time period activeTime by one, namely, activeTime-=1.

Operation 10. The first terminal determines whether the active time period activeTime is equal to 0. If yes, it satisfies activeTime=0, and operation 11 is executed. If no, i.e., activeTime≠0, such as activeTime>0, the first virtual object may continue to maintain the interactive state, isActive=True, and return to operation 5.

Operation 11. The first terminal hides the action marker above the head of the first virtual object, disables the interactive state of the first virtual object, and sets the interaction state parameter isActive=False.

In the method provided according to the embodiments of this application, entity interaction and quick response are achieved through the action markers in the virtual scenario, thus promoting the desire of the players for multiplayer interaction, lowering an operation barrier, and enhancing the sense of presence and sense of substitution of the players in social interaction. This technical solution emphasizes the real-time nature and fun of multiplayer interaction, and supports multiple players to simultaneously perform an interaction such as high five. Through a vivid and object-specific interaction mode, it promotes friendly interactions between teammates and between strangers. This technical solution can be used in application scenarios such as team cheering in a game, birth island socialization, and expressing friendliness before confrontation, increasing an opportunity of establishing connections between the players, and enhancing game socialization experience of the players.

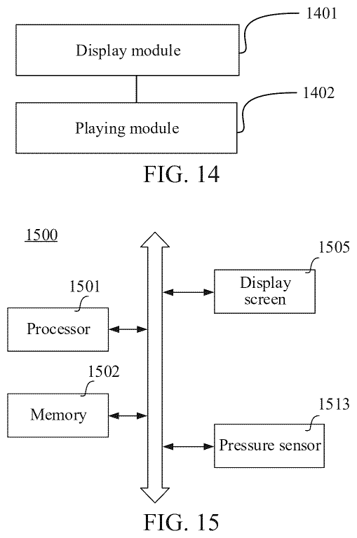

FIG. 14 is a schematic structural diagram of an interaction apparatus based on virtual objects according to an embodiment of this application. Referring to FIG. 14, the apparatus includes:
a display module 1401, configured to display an interaction interface, one or more selectable interactions being displayed on the interaction interface;
the display module 1401 being further configured to display, in response to a trigger operation for any interaction, an action marker of the interaction associated with a first virtual object; and
a playing module 1402, configured to: when at least one second virtual object appears within an interaction range of the first virtual object and carries the action marker of the interaction, play a marker fusion special effect based on a plurality of action markers within the interaction range, the marker fusion special effect providing an interaction special effect when the plurality of action markers converge, and the plurality of action markers including the action marker displayed based on the first virtual object and the action marker carried by the at least one second virtual object.

According to the apparatus provided by this embodiment of this application, by providing a quick interaction mode based on interactions, a user can control a first virtual object to initiate any interaction after opening an interaction interface through an interaction control, and combine and play a marker fusion special effect according to second virtual objects that initiate the same interaction within an interaction range of the first virtual object, to indicate that an action marker of the first virtual object and action markers of the second virtual objects converge through multiplayer interaction, thus displaying and providing a multiplayer social interaction form between two or more virtual objects, enriching the interaction modes based on the interactions, increasing a degree of integration with a virtual scenario, improving a real-time interaction feeling and immersive feeling, and improving the human-computer interaction efficiency.

In some embodiments, based on the apparatus composition in FIG. 14, the playing module 1402 includes:
a generation unit, configured to generate the marker fusion special effect based on the plurality of action markers within the interaction range;
a determining unit, configured to determine a special effect display position based on a position of the first virtual object and a position of the at least one second virtual object; and
a playing unit, configured to play the marker fusion special effect at the special effect display position.

In some embodiments, a number of the second virtual object is one, and the determining unit is configured to: determine a line segment formed by the position of the first virtual object and the position of the second virtual object; and determine the special effect display position based on a midpoint of the line segment.

In some embodiments, a number of the second virtual object is plurality, and the determining unit is configured to: determine a polygon using the position of the first virtual object and the positions of the plurality of second virtual objects as vertexes; and determine the special effect display position based on a geometric center of the polygon.

In some embodiments, based on the apparatus composition in FIG. 14, the apparatus further includes:
a first generation module, configured to detect, within a target time period, the number of the second virtual objects that carry the action marker within the interaction range; and generate the marker fusion special effect based on the action marker carried by the first virtual object and the action markers carried by the second virtual objects that satisfy the number.

In some embodiments, the target time period uses a moment when a second virtual object that carries the action marker has been detected for the first time within the interaction range as a starting point of timing, and the target time period lasts for a target duration from the starting point of timing.

The first generation module is configured to: detect, within an active time period of the action marker of the first virtual object, a second virtual object that carries the action marker within the interaction range; by using the moment when the second virtual object that carries the action marker has been detected for the first time as the starting point of timing, within the target duration after the starting point of timing, add the detected second virtual objects that carry the action marker into an interaction list; and determine a list length of the interaction list to be the number.

In some embodiments, based on the apparatus composition in FIG. 14, the apparatus further includes:
a second generation module, configured to: generate, based on the plurality of action markers and display positions of the plurality of action markers, a marker fusion special effect of converging the plurality of action markers from the respective display positions to a specified position.

In some embodiments, the plurality of action markers are hidden during the playing of the marker fusion special effect.

In some embodiments, based on the apparatus composition in FIG. 14, the display module 1401 includes:
a display unit, configured to display the action marker of the interaction within a target range of the first virtual object.

In some embodiments, the display unit is configured to:
configure the first virtual object to be in an interactive state;
set the active time period of the action marker of the interaction for the first virtual object that is in the interactive state; and
display the action marker of the interaction within the target range within the active time period.

In some embodiments, the display unit is configured to: control the first virtual object to perform the interaction, and display the action marker of the interaction within the target range of the first virtual object after the performing of the interaction is completed.

In some embodiments, the second virtual object is caused to also carry the action marker by performing a trigger operation on the action marker of the first virtual object.

In some embodiments, the display module 1401 is further configured to configure the action marker of the first virtual object to be in an interactive state when the second virtual object is located in the interaction range of the first virtual object.

The second virtual object is caused to also carry the action marker by performing a trigger operation on the action marker in the interactive state of the first virtual object.

In some embodiments, a special effect intensity of the marker fusion special effect is in positive correlation with a number of the plurality of action markers.

In some embodiments, the display module 1401 is configured to: display the interaction interface in response to a trigger operation for an interaction control; or, display the interaction interface in response to a touchhold operation for the first virtual object; or, display the interaction interface in response to a specific gesture in a virtual scenario where the first virtual object is located.

In some embodiments, the one or more selectable interactions are displayed through an interaction wheel; the interaction wheel is divided into a plurality of sector regions; one selectable interaction is displayed in each sector region.

The trigger operation for the any interaction includes: a tap operation for the sector region where the any interaction is located in the interaction wheel; or, a slide operation from a center region of the interaction wheel to the sector region where any interaction is located.

In some embodiments, the display module 1401 is further configured to: if the first virtual object and any second virtual object are in a non-friend relationship, pop up a friend add control for the any second virtual object or send a friend add request to the any second virtual object; and if the first virtual object and any second virtual object are in a friend relationship, increase a virtual intimacy between the first virtual object and the any second virtual object.

All the foregoing exemplary technical solutions can be combined in different manners to form exemplary embodiments of the present disclosure, and details are not described herein.

In addition, the interaction apparatus based on virtual objects according to the foregoing embodiments is illustrated with an example of division of the foregoing functional modules when multiplayer interaction is initiated based on the virtual objects. In practical applications, the functions may be assigned to and completed by different functional modules according to requirements, namely, the internal structure of the electronic device is divided into different functional modules, to implement all or some of the functions described above. In addition, the interaction apparatus based on virtual objects according to the above embodiments and the interaction method based on virtual objects belong to the same concept. For its specific implementation process, refer to the embodiments of the interaction method based on virtual objects, details of which are not elaborated here.

FIG. 15 is a schematic structural diagram of an electronic device according to an embodiment of this application. As shown in FIG. 15, the electronic device being a terminal 1500 is use for description. In some embodiments, a device type of the terminal 1500 includes: a smartphone, a tablet computer, a moving picture experts group audio layer III (MP3) player, a moving picture experts group audio layer IV (MP4) player, a notebook computer, or a desktop computer. The terminal 1500 may also be referred to as another name such as user equipment, a portable terminal, a laptop terminal, or a desktop terminal.

The terminal 1500 generally includes: a processor 1501 and a memory 1502.

In some embodiments, the processor 1501 includes one or more processing cores, for example, a 4-core processor or an 8-core processor. In some embodiments, the processor 1501 may be implemented in at least one hardware form of a digital signal processor (DSP), a field-programmable gate array (FPGA), and a programmable logic array (PLA). In some embodiments, the processor 1501 includes a main processor and a coprocessor. The main processor is configured to process data in an active state, also referred to as a central processing unit (CPU). The coprocessor is a low power processor configured to process the data in a standby state. In some embodiments, the processor 1501 may be integrated with a graphics processing unit (GPU). The GPU is configured to render and draw content that needs to be displayed on a display screen. In some embodiments, the processor 1501 may further include an artificial intelligence (AI) processor. The AI processor is configured to process computing operations related to machine learning.

In some embodiments, the memory 1502 includes one or more computer-readable storage media. In some embodiments, the computer-readable storage media are non-transitory. In some embodiments, the memory 1502 further includes a high-speed random-access memory and a non-transitory memory, for example, one or more disk storage devices or flash storage devices. In some embodiments, the non-transitory computer-readable storage media in the memory 1502 are configured for storing at least one program code, and the at least one program code is configured for being run by the processor 1501 to cause the terminal 1500 to implement the interaction method based on the virtual objects according to the embodiments of this application.

In some embodiments, the terminal 1500 further includes: a display screen 1505 and a pressure sensor 1513.

The display screen 1505 is configured to display a user interface (UI). In some embodiments, the UI may include a graph, text, an icon, a video, and any combination thereof. When the display screen 1505 is a touch display screen, the display screen 1505 further has a capability of acquiring a touch signal on or above a surface of the display screen 1505. The touch signal may be inputted to the processor 1501 for processing as a control signal. In some embodiments, the display screen 1505 is further configured to provide virtual buttons and/or a virtual keyboard that are/is also referred to as soft buttons and/or a soft keyboard. In some embodiments, there is one display screen 1505 arranged on a front panel of the terminal 1500. In some other embodiments, there are at least two display screens 1505 which are respectively arranged on different surfaces of the terminal 1500 or are folded. In some other embodiments, the display screen 1505 is a flexible display screen arranged on a curved surface or a folded surface of the terminal 1500. Even, in some embodiments, the display screen 1505 is configured into a non-rectangular irregular pattern, i.e., a special-shaped screen. In some embodiments, the display screen 1505 is manufactured by using a material such as a liquid crystal display (LCD) or an organic light-emitting diode (OLED). Illustratively, an interaction interface is displayed based on the display screen 1505, and a marker fusion special effect is played on the display screen 1505.

In some embodiments, the pressure sensor 1513 is arranged at a side frame of the terminal 1500 and/or on a lower layer of the display screen 1505. When the pressure sensor 1513 is arranged at the side frame of the terminal 1500, a holding signal of a user on the terminal 1500 can be detected. The processor 1501 recognizes the left hand or the right hand or performs a quick operation according to the holding signal acquired by the pressure sensor 1513. When the pressure sensor 1513 is arranged on the low layer of the display screen 1505, the processor 1501 controls an operable control on the UI according to a press operation performed by the user on the display screen 1505. The operable control includes at least one of a button control, a scroll-bar control, an icon control, and a menu control. In some embodiments, when the pressure sensor 1513 is arranged on the lower layer of the display screen 1505, the pressure sensor 1513 may also be referred to as a touch sensor.

A person skilled in the art can understand that the structures shown in FIG. 15 do not constitute a limitation on the terminal 1500, and can include more or fewer components than those shown in the figure, or combine some components, or use different component arrangements.

In an exemplary embodiment, a non-transitory computer-readable storage medium is further provided, for example, a memory including at least one computer program. The at least one computer program may be run by a processor in an electronic device to cause a computer to implement the interaction method based on virtual objects in the foregoing embodiments. For example, the non-transitory computer-readable storage medium includes a read-only memory (ROM), a random-access memory (RAM), a compact disc read-only memory (CD-ROM), a magnetic tape, a floppy disk, an optical data storage device, and the like.

In an exemplary embodiment, a computer program product is further provided, including one or more computer programs stored in a non-transitory computer-readable storage medium. One or more processors of an electronic device can read the one or more computer programs from the non-transitory computer-readable storage medium, and the one or more processors run the one or more computer programs to cause the electronic device to perform the interaction method based on virtual objects in the foregoing embodiments.

A person of ordinary skill in the art can understand that all or some of the operations of the embodiments may be implemented by hardware or a program instructing relevant hardware. In some embodiments, the program is stored in a non-transitory computer-readable storage medium. In some embodiments, the storage medium mentioned above is an ROM, a magnetic disk, a compact disc, or the like.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The foregoing descriptions are merely some embodiments of this application, but are not intended to limit this application. Any modification, equivalent replacement, or improvement made within the principle of this application shall fall within the protection scope of this application.

What is claimed is:

1. A method for performing interactions between virtual objects in a virtual environment performed by an electronic device, the method comprising:
displaying an interaction interface, the interface including one or more selectable interactions;
in response to a trigger operation for any interaction, displaying an action marker of the interaction associated with a first virtual object; and
when at least one second virtual object appears within an interaction range of the first virtual object and carries the action marker of the interaction, playing a marker fusion special effect based on a plurality of action markers within the interaction range, the marker fusion special effect providing an interaction special effect when the plurality of action markers converge within the interaction range.

2. The method according to claim 1, wherein the playing a marker fusion special effect based on a plurality of action markers within the interaction range comprises:
generating the marker fusion special effect based on the plurality of action markers within the interaction range;
determining a special effect display position based on a position of the first virtual object and a position of the at least one second virtual object; and
playing the marker fusion special effect at the special effect display position.

3. The method according to claim 2, wherein a number of the second virtual object is one, and the determining a special effect display position based on a position of the first virtual object and a position of the at least one second virtual object comprises:
determining a line segment formed by the position of the first virtual object and the position of the second virtual object; and
determining the special effect display position based on a midpoint of the line segment.

4. The method according to claim 2, wherein a number of the second virtual object is a plurality, and the determining a special effect display position based on a position of the first virtual object and a position of the at least one second virtual object comprises:
determining a polygon using the position of the first virtual object and the positions of the plurality of second virtual objects as vertexes; and
determining the special effect display position based on a geometric center of the polygon.

5. The method according to claim 1, further comprising:
detecting, within a target time period, the number of the second virtual objects that carry the action marker within the interaction range; and
generating the marker fusion special effect based on the action marker carried by the first virtual object and the action markers carried by the second virtual objects that satisfy the number.

6. The method according to claim 5, the target time period uses a moment when a second virtual object that carries the action marker has been detected for the first time within the interaction range as a starting point of timing, and the target time period lasts for a target duration from the starting point of timing;
the detecting, within a target time period, the number of the second virtual objects that carry the action marker within the interaction range comprises:
detecting, within an active time period of the action marker of the first virtual object, the second virtual objects that carry the action marker within the interaction range;
by using the moment when the second virtual object that carries the action marker has been detected for the first time as the starting point of timing, within the target duration after the starting point of timing, adding the detected second virtual objects that carry the action marker into an interaction list; and
determining a list length of the interaction list to be the number.

7. The method according to claim 1, further comprising:
generating, based on the plurality of action markers and display positions of the plurality of action markers, a marker fusion special effect of converging the plurality of action markers from the respective display positions to a specified position.

8. The method according to claim 1, wherein the plurality of action markers are hidden during the playing of the marker fusion special effect.

9. The method according to claim 1, wherein the displaying an action marker of the interaction associated with a first virtual object comprises:
displaying the action marker of the interaction within a target range of the first virtual object.

10. The method according to claim 9, wherein the displaying the action marker of the interaction within a target range of the first virtual object comprises:
configuring the first virtual object to be in an interactive state;
setting the active time period of the action marker of the interaction for the first virtual object that is in the interactive state; and
displaying the action marker of the interaction within the target range within the active time period.

11. The method according to claim 9, wherein the displaying the action marker of the interaction within a target range of the first virtual object comprises:
controlling the first virtual object to perform the interaction, and displaying the action marker of the interaction within the target range of the first virtual object after the performing of the interaction is completed.

12. The method according to claim 1, wherein the second virtual object is configured to carry the action marker by performing a trigger operation on the action marker of the first virtual object.

13. The method according to claim 12, further comprising:
configuring the action marker of the first virtual object to be in an interactive state when the second virtual object is located in the interaction range of the first virtual object; and
the second virtual object is caused to also carry the action marker by performing a trigger operation on the action marker, which is in the interactive state, of the first virtual object.

14. The method according to claim 1, wherein a special effect intensity of the marker fusion special effect is in positive correlation with a number of the plurality of action markers.

15. The method according to claim 1, wherein the displaying an interaction interface comprises:
displaying the interaction interface in response to a trigger operation for an interaction control; or,
displaying the interaction interface in response to a touchhold operation for the first virtual object; or,
displaying the interaction interface in response to a specific gesture in a virtual scenario where the first virtual object is located.

16. The method according to claim 1, wherein the one or more selectable interactions are displayed through an interaction wheel; the interaction wheel is divided into a plurality of sector regions; one selectable interaction is displayed in each sector region; and
the trigger operation for the any interaction comprises at least one of: a tap operation for the sector region where the any interaction is located in the interaction wheel; and a slide operation from a center region of the interaction wheel to the sector region where the any interaction is located.

17. The method according to claim 1, further comprising:
when the first virtual object and any second virtual object are in a non-friend relationship, popping up a friend add control for the any second virtual object or transmitting a friend add request to the any second virtual object; and
when the first virtual object and any second virtual object are in a friend relationship, increasing a virtual intimacy between the first virtual object and the any second virtual object.

18. An electronic device, comprising one or more processors and one or more memories, the one or more memories having at least one computer program stored therein, and the at least one computer program, when executed by the one or more processors, causing the electronic device to implement a method for performing interactions between virtual objects in a virtual environment including:
displaying an interaction interface, the interface including one or more selectable interactions;
in response to a trigger operation for any interaction, displaying an action marker of the interaction associated with a first virtual object; and
when at least one second virtual object appears within an interaction range of the first virtual object and carries the action marker of the interaction, playing a marker fusion special effect based on a plurality of action markers within the interaction range, the marker fusion special effect providing an interaction special effect when the plurality of action markers converge within the interaction range.

19. The electronic device according to claim 18, wherein the playing a marker fusion special effect based on a plurality of action markers within the interaction range comprises:
generating the marker fusion special effect based on the plurality of action markers within the interaction range;
determining a special effect display position based on a position of the first virtual object and a position of the at least one second virtual object; and
playing the marker fusion special effect at the special effect display position.

20. A non-transitory computer-readable storage medium, having at least one computer program stored therein, and the at least one computer program, when executed by a processor of an electronic device, causing the electronic device to implement a method for performing interactions between virtual objects in a virtual environment including:
displaying an interaction interface, the interface including one or more selectable interactions;
in response to a trigger operation for any interaction, displaying an action marker of the interaction associated with a first virtual object; and
when at least one second virtual object appears within an interaction range of the first virtual object and carries the action marker of the interaction, playing a marker fusion special effect based on a plurality of action markers within the interaction range, the marker fusion special effect providing an interaction special effect when the plurality of action markers converge within the interaction range.
